(19) United States
(12) Patent Application Publication
(10) Pub. No.: US 2006/0249186 A1
(43) Pub. Date: Nov. 9, 2006

(54) Heated liquid cleaner

(76) Inventors: Martin A. Cohen, Ridgefield, CT (US); Vito James Carlucci, Stratford, CT (US); Paul J. Carrubba, Baldwin, NY (US); Paul J. Denhup, Stratford, CT (US)

Correspondence Address: STEVEN A. GARNER, ESQ.;CONAIR CORPORATION, ONE CUMMINGS POINT ROAD, STAMFORD, CT, 06902, US

(21) Appl. No.: 11/415,896

(22) Filed: May 2, 2006

Related U.S. Application Data
(60) Provisional application No. 60/676,780, filed on May 2, 2005.
(60) Provisional application No. 60/677,110, filed on May 3, 2005.

(51) Int. Cl. B08B 3/12; B08B 3/00

(52) U.S. Cl. 134/184; 134/193; 134/188; 134/198

(57) ABSTRACT

A rechargeable hand held or floor supported multi surface cleaner is adapted to use rechargeable, dry cell batteries or a line cord connected supply to power one or more rotating power drives or counter rotational or linear power drives and cleaning brushes. The unit can dispense hot, warm or ambient detergent solution in order to facilitate cleaning. A docking station is provided to recharge the cleaning unit batteries, to heat the detergent solution and to refill the unit's detergent bottle from a larger interchangeable reservoir located in the docking station. Disposable as well as non-disposable attachments are provided with extension wands to clean various surfaces including conditions and hard to reach areas. A floor cleaner component uses the same interchangeable detergent bottle for cleaning.

### CROSS-REFERENCE TO RELATED APPLICATIONS

This application is related to and claims priority from provisional patent applications 60/676,780 filed May 20, 2005 titled “MULTI-SURFACE CLEANING APPARATUS” and 60/677,110 filed May 03, 2005 “MULTI-SURFACE CLEANING APPARATUS WITH AUTO-REFILL”.

### BACKGROUND OF THE INVENTION

1. Field of the Invention

The present invention relates to cleaning appliances and, more particularly, to electrical-mechanical cleaning appliances that have versatile modes of configuration and use and are adapted for a variety of cleaning applications.

2. Description of Related Art

Various known cleaning appliances are limited to one or a few uses, thus requiring a user to possess or obtain more than one appliance. For example, certain appliances are limited to moving brushes or to steam delivery. Others are limited to battery power and still others are limited to live current. These are among numerous variations in components and function that exist in separate appliances. A user who desires these functions and more is required to own, store, maintain and learn to utilize numerous appliances, with obvious drawbacks in cost, space, complexity and other areas.

### OBJECTS AND BRIEF SUMMARY OF THE INVENTION

It is an object of the present invention to provide a multi-function, multiple-configuration cleaning appliance that overcomes the shortcomings mentioned above. These and other objects are achieved by the presently described invention.

According to the present invention, a rechargeable hand held or floor supported multi surface cleaner is adapted to use rechargeable, dry cell batteries or a line cord connected supply to power one or more rotating power drives or counter rotational or linear power drives and cleaning brushes. The unit can dispense hot, warm or ambient detergent solution in order to facilitate cleaning. A docking station is provided to recharge the cleaning unit batteries, to heat the detergent solution and to refill the unit's detergent bottle from a larger interchangeable reservoir located in the docking station. Disposable as well as non-disposable attachments are provided with extension wands to clean various surfaces including conditions and hard to reach areas. A floor cleaner component uses the same interchangeable detergent bottle for cleaning. A floor cleaning embodiment will also boil water for steam cleaning.

### BRIEF DESCRIPTION OF THE DRAWINGS

FIG. 1 is a side cross-sectional, schematic drawing of a first embodiment according to the present invention.

FIG. 2 is a side cross-sectional, schematic drawing of a second embodiment according to the present invention.

FIG. 3 is a side cross-sectional, schematic drawing of a third embodiment according to the present invention.

FIGS. 4A and 4B are, respectively, a side cross-sectional, schematic drawing and a rear cross-sectional, schematic drawings of a fourth embodiment according to the present invention.

FIGS. 5A, 5B and 5C are, respectively, FIGS. 4A and 4B are, respectively, a side cross-sectional, schematic drawing; and two bottom, schematic drawings of a fifth embodiment according to the present invention.

FIGS. 6A, 6B and 6C are, respectively, a side cross-sectional, schematic drawing; and exploded schematic drawing; and a side view of a sixth embodiment according to the present invention.

FIG. 7 is a side cross-sectional, schematic drawing of another embodiment according to the present invention.

### DETAILED DESCRIPTION OF THE PREFERRED EMBODIMENTS OF THE INVENTION

With respect to each embodiment identified, like reference numerals are used in order to facilitate understanding of similarity in design and function for like-numbered components.

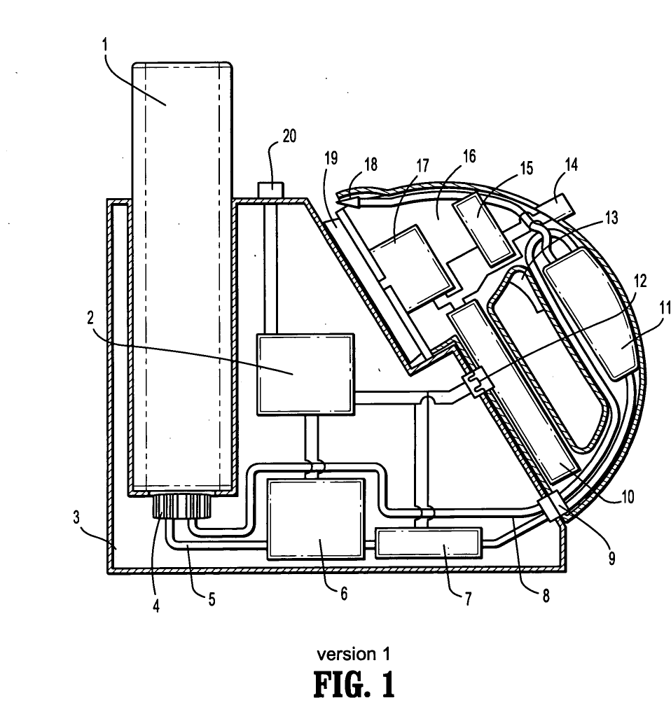

As shown in FIG. 1, an auto-refill cleaning appliance according to the present invention with a docking station comprises a hand held unit (16) which is placed in the docking station (3). A refill pump (6) is activated by a manual switch (20) or starts automatically. This action refills the holding tank (11) in the unit (16) with hot, warm or ambient cleaning solution. The solution is heated as well as circulated through a thermostatically controlled in-line heater (7), which is also controlled by a switch (20) and can be shut off if no heat is desired. The solution is dispensed through a single or multi orifice nozzle (18) onto the surface to be cleaned or injected through the rotating brushes. The product can be designed to use rechargeable, dry cell batteries (10) or a line cord connected supply to power one or more rotating power drives (17) or counter rotational or linear power drives and cleaning brushes (19) used to facilitate cleaning. With battery use, the docking station (3) can be designed as a fast or trickle charge system (2) to recharge the hand held unit batteries (10) via charging contacts or induction means (12). Detergent solution flows through a single direction check valve system that has an “out” (5) and an “in” (7) location for solution or air to flow (4). The aforementioned solution circuitry is connected to an electric or manual pump (6). Fluid is drawn from tube (5) by pump (6) and heated by heater (7). Hose (8) returns cleaning solution to the replaceable cleaning solution bottle as a means for controlling overflow. A second check valve fitting system (9) is used to direct cleaning solution to the cleaning unit (16). A large interchangeable refillable detergent mixing bottle (1) is used to automatically refill the smaller holding tank in the unit (11) when placed in the docking station (3). Replaceable manually released (button not shown) cleaning pads are provided to eliminate touching and cleaning attachment heads. Non-disposable attachment heads and extension wands can be provided for multiple cleaning tasks and hard to reach places.

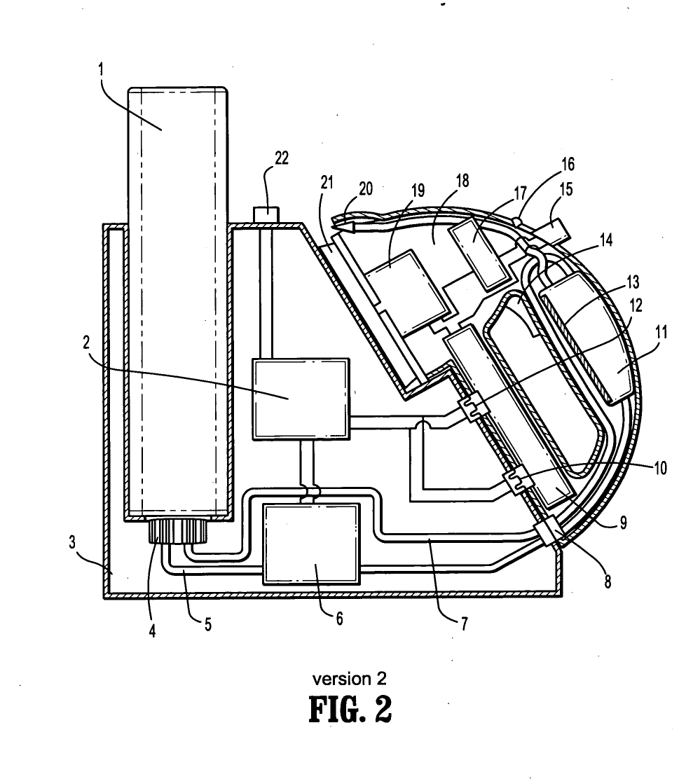

Referring to FIG. 2, an appliance like that disclosed in the first embodiment differs in that the heating system is in the hand held component. The solution is heated in a small holding reservoir on the unit (11) by a thermostatically controlled heating plate with electrical contacts. The detergent solution is dispensed by an electric or manual trigger pump (15) when the trigger (14) is pressed and liquid flows through a nozzle (20) onto the surface to be cleaned. The removable unit can be designed to have a ready indication light to alert the consumer that the liquid has been heated to the proper temperature or the level is too low. This hand held or floor supported unit can be designed with an auto-off control system that will automatically shut the unit off if it has been on for an extended period of time

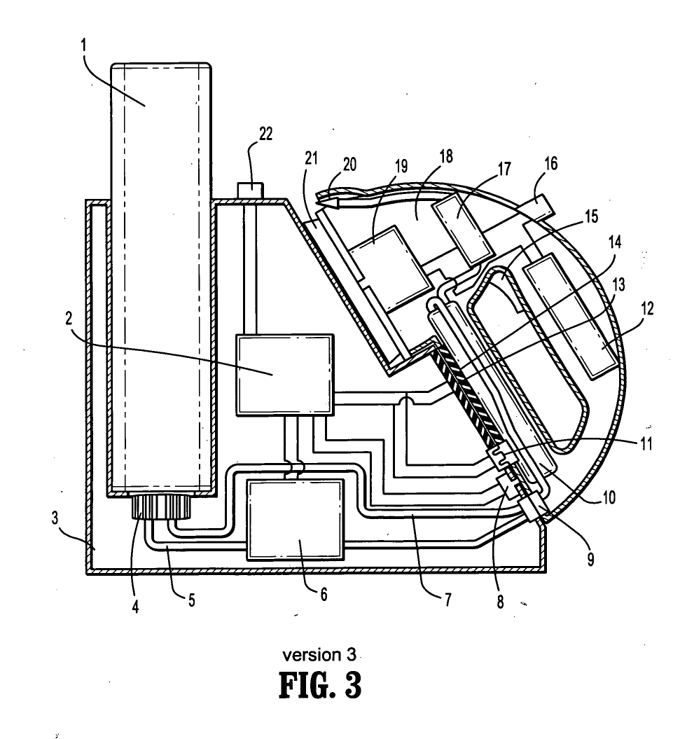

As shown in FIG. 3, another embodiment has an alternate heating system by means of thermal conduction on the docking station. The solution is heated by a metal heating plate or projection (13) on the docking station (3) through conduction to another metal plate or depression (14) located on the unit (18). The heater can be designed to be controlled by electronic or manual means (8) that is activated by placing unit (18) on docking station (3). A protective covering means can be designed to ensure that the heated plates or projections cannot come in contact with the users hands or other heat sensitive areas or items.

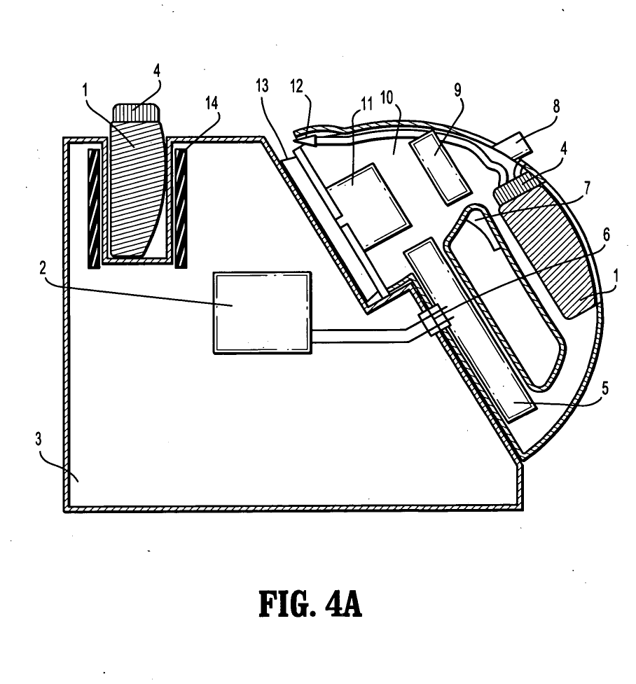

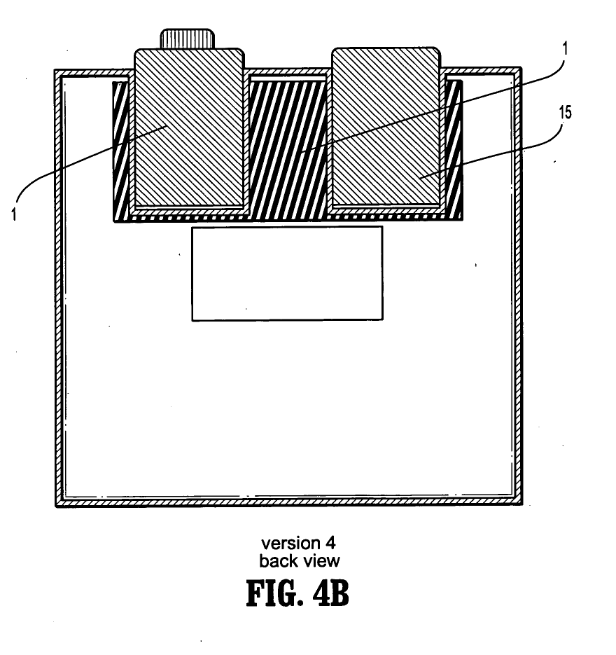

A fourth embodiment is illustrated in FIGS. 4A and 4B, in which the docking station will use interchangeable bottles or bags heated by convection in order to replenish the hand held unit (refer to version 4). The docking station (3) has one or more ports to heat a predetermined size bottle or sealed PVC bag of cleaning fluid. Heating is done by use of a heating plate (1) that makes direct contact with the outer surface of the cleaning bottle or sealed PVC bag. If a bottle is used, detergent solution is circulated through a single direction valve system that has an “out” and an “in” for solution or air to flow (12), which in turn is connected to an electric or manual pump (2). If a sealed PVC bag (15) is used there is no need to provide a single directional valve (6), as the bag will compress during use. The PVC bag (15) can be designed to conform to the heater plates in order to provide optimum thermally conductive heat transfer.

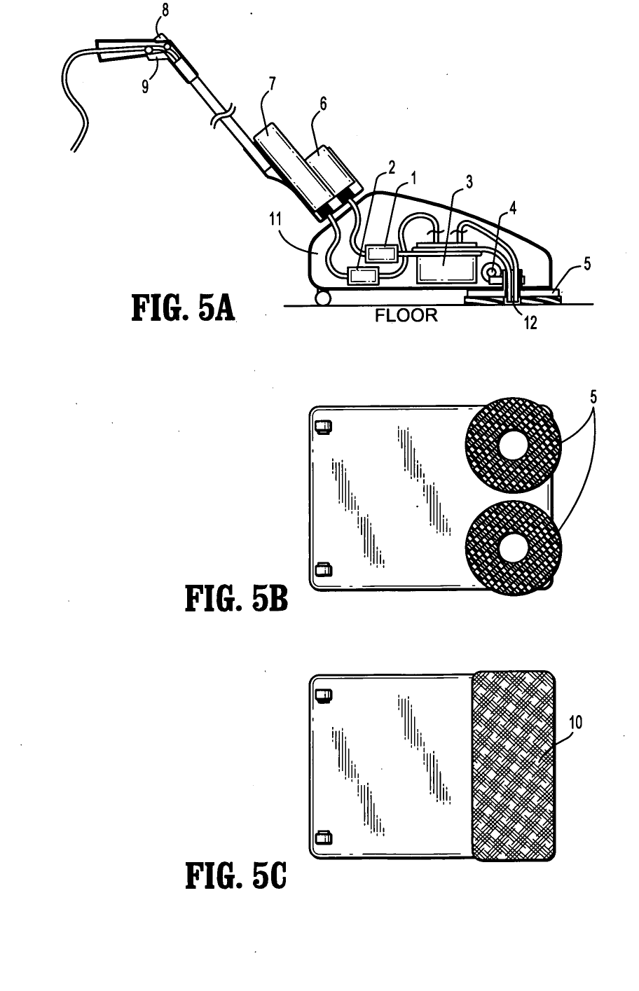

In a fifth embodiment, shown in FIGS. 5A, 5B and 5C, a floor-supported cleaner has cleaning bottles that fit in a hand held embodiment. A hard surface floor cleaner (11) can be designed to accommodate the same detergent bottle or sealed PVC bag (6) or (7) used in the hand held device. The detergent bottle (6) will be connected to an electric or manual pump (1) that will dispense detergent into the unit's heater (3). Heater (3) will be controlled by a switch (8) that will turn heat off if not desired. The heat source can be an immersion heater or a flash boiler. Once heated, the cleaning solution will be dispensed by depressing trigger switch (9) through a nozzle (12) on to 1 or more rotating brushes (5) for cleaning. The brushes are controlled by a switch (8&9), which will activate the motor or motor drives (4) that in turn will rotate the cleaning brushes. One or more brush speeds are to be used. In addition to the cleaning detergent, a second bottle (7) with water only is provided. When using water only, a second cal rod is activated in the heater (3) by a switch (8) to boil water for steam cleaning. If a second cal rod is not used, the cleaning fluid can be heated through conduction around the steam chamber.

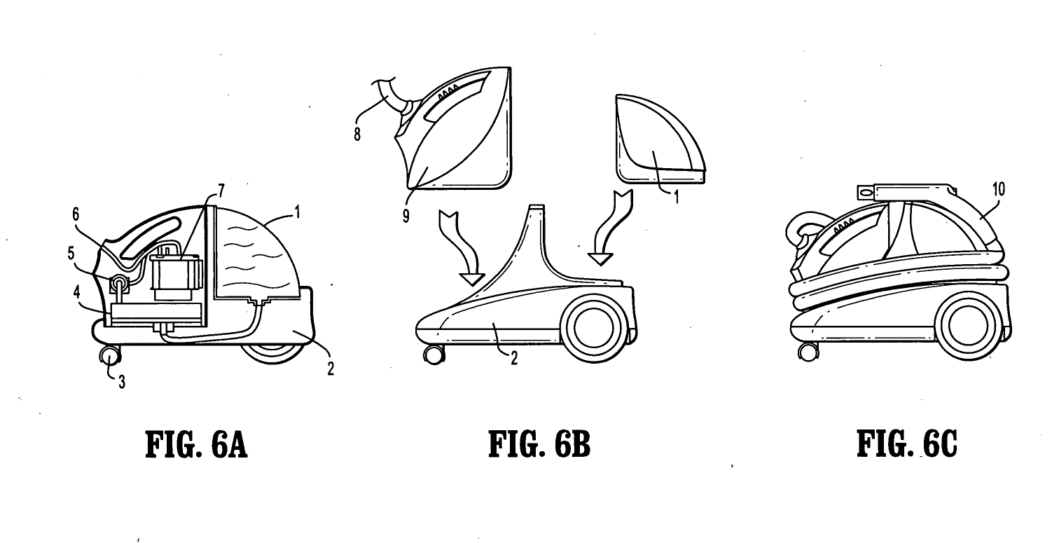

FIGS. 6A, 6B and 6C illustrate yet another possible configuration.

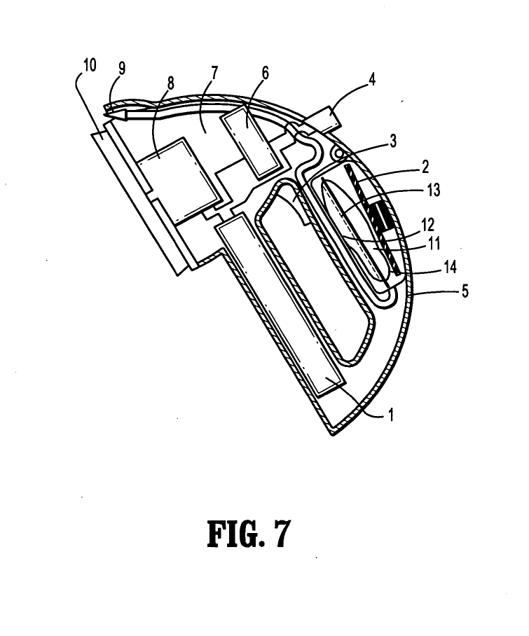

Referring to FIG. 7, the multi-surface cleaner (7) according to another embodiment of the invention has either a one-shot or multiple-use self-heated liquid cleaning bag (14). The cleaning bag (14) has two chambers sealed and separated by a seam (13) formed by radio frequency (RF), sonic welding or heat, so that a cleaning liquid stored in a first chamber (11) and heat-producing substances in a second chamber (12) are kept apart from each other. The cleaning bag (14) is inserted into the multi-surface cleaner (7) in order to apply a cleaning solution to the surface being cleaned. The multi-surface cleaner (7) has internal structures (not shown) that puncture the cleaning bag (14), thereby allowing the two chambers' (11, 12) contents to mix and form a cleaning solution. The cleaner (7) has an internal pump (6) to move the cleaning solution through rotating brushes (10) and on to the surface to be cleaned. At the time the bag (14) is punctured, liquid from the first chamber (11) is mixed with a chemical from the second chamber (12) to form an exothermic reaction, thereby heating the cleaning solution due to the heat of solution of the mixed chemicals. There are various different known chemicals that when mixed form an exothermic reaction suitable for this use. While the pump (6) is operating, mixing of the cleaning solution occurs at the nozzle (9) thereby heating the cleaning solution while it is being dispensed. The bag (14) collapses until its contents empty. An indicator light may be used to alert the user to refill or replace the cleaning bag.

Alternatively, the cleaning solution can be mixed in one section of the bag (14) upon breaking of the seam (13), rather than mixing the contents of the two sections (11, 12) at the nozzle (9).

In yet another alternative, heating is provided through conduction rather than direct chemical reaction in the cleaning solution.

Another alternative is to use three chambers in the bag (10), whereby a cleaning solution is stored in one chamber; a heating substance is separated in another chamber; and a reactive water or liquid is held in a third chamber. The seam between the water and the heating substance is designed to break easily, starting the exothermic reaction. The cleaning solution is heated through conduction and does not mix with the heating substance and water, since the seam separating the cleaning solution is designed not to break.

While the preferred embodiment of the present invention has been herein described, various modification may be made without departing from the scope of the present invention.

What is claimed is:

1) A cleaning appliance for dispensing a cleaning liquid, said appliance comprising
a liquid receiving tank for receiving liquid;
a liquid holding tank;
a dispensing nozzle;
a first pump that delivers said liquid from said receiving tank to said holding tank; and
a second pump that causes said liquid to be selectively dispensed.

2) A cleaning appliance according to claim 1, wherein
said first pump is manually activated.

3) A cleaning appliance according to claim 1, wherein
said first pump is automatically activated.
